(19) United States
(12) Patent Application Publication
(10) Pub. No.: US 2026/0259323 A1
(43) Pub. Date: Sep. 3, 2026

(54) LASER TRIANGULATION SENSOR ARRANGEMENT

(71) Applicant: FNV IP B.V., Leidschendam (NL)

(72) Inventors: Morgan Dewey REED, Lafayette, LA (US); Ryan Mumford TWILLEY, Lafayette, LA (US); Matthew John CONNELLY-TAYLOR, Paris (CA)

(73) Assignee: FNV IP B.V., Leidschendam (NL)

(21) Appl. No.: 19/066,641

(22) Filed: Feb. 28, 2025

(51) Int. Cl. G01S 17/48; G01S 7/487; G01S 17/89

(52) U.S. Cl. CPC G01S 17/48; G01S 7/4873; G01S 17/89

(57) ABSTRACT

A laser triangulation sensor arrangement for measuring a surface profile is provided. The laser triangulation sensor arrangement has multiple sensors arranged to receive reflections of light within different laser light frequency bandwidths. Filtering means are provided in front of each sensor to selectively permit reflected laser light within a certain frequency bandwidth while blocking light in another frequency bandwidth to avoid interference. A survey mechanism and vehicle comprising such a laser triangulation sensor arrangement are also provided. Unlocking insights from geodata, the present disclosure further relates to improvements in sustainability and environmental developments: together we create a safe and liveable world.

### TECHNICAL FIELD OF THE INVENTION

The present technology relates to a laser triangulation sensor arrangement for measuring a three-dimensional topography of a surface. The present technology further relates to a survey mechanism and vehicle including such a laser triangulation sensor arrangement. The present technology further relates to a method for measuring a three-dimensional topography of a surface using a vehicle that moves along a trajectory. Unlocking insights from geodata, the present disclosure further relates to improvements in sustainability and environmental developments: together we create a safe and liveable world.

### BACKGROUND

Laser triangulation can be used to conduct surveys and/or collect data in various fields such as land surveying, geographic information systems (GIS), construction, environmental monitoring, and scientific research. For example, a laser triangulation sensor arrangement can be included in a survey mechanism that is integrated with or detachably mounted to a vehicle to carry out a pavement survey and collect data regarding a topography and texture of pavement. Such pavement surveys can provide valuable insights into the need to repair cracks or potholes in the pavement, for example.

Laser triangulation sensor arrangements with a single sensor have a limited field of view due to a fixed observation angle and target area wherein the sensor is in focus. A possible solution is to arrange the sensor further away from the surface so as to increase the target area. Disadvantageously, however, this places the laser triangulation sensor arrangement in a relatively vulnerable position, e.g., typically above the roof of the vehicle where it is attached to. Such positioning increases the likelihood that the laser triangulation sensor arrangement gets damaged. In addition, such positioning may limit the applicability of a survey mechanism with laser triangulation sensor arrangement. In particular, bridges, low-hanging branches, and other obstacles above the target area may impose a maximum height of a vehicle including a survey mechanism with laser sensor arrangement.

It would be advantageous to provide an improved laser triangulation sensor arrangement that has an increased field of view and/or addresses any of the disadvantages as explained above.

### SUMMARY

Therefore, according to a first aspect of the invention, there is provided a laser triangulation sensor arrangement for measuring a surface profile, the laser triangulation sensor arrangement comprising a first laser triangulation sensor arranged to receive a reflection of light emitted by a first laser source within a first laser light frequency bandwidth; a second laser triangulation sensor arranged to receive a reflection of light emitted by a second laser source within a second laser light frequency bandwidth; first filtering means preventing the first laser triangulation sensor from receiving light within the second bandwidth; and second filtering means preventing the second laser triangulation sensor from receiving light within the first bandwidth.

In this context, the term “laser triangulation” is used to refer to the technique of measuring distances or shapes using a laser beam. Laser triangulation includes both line laser triangulation wherein a 2D surface profile is made, and area laser triangulation wherein a 3D profile of the object is made. Laser line triangulation may be used in combination with a moveable setup of the laser triangulation sensor arrangement; i.e., by repeatedly measuring a 2D surface profile and moving the laser triangulation sensor arrangement along a trajectory, a 3D profile may be obtained.

Advantageously, due to the provision of multiple triangulation sensors in the laser sensor arrangement, a larger area or a longer line can be accurately measured in comparison to when only a single laser triangulation sensor would be used. In order to obtain a continuous mapping of the surface profile, the field of view of the first and second laser triangulation sensors must overlap. The first and second filtering means are arranged to prevent interference between the received light signals from the first and second laser source. This allows accurate measurements to be made using both the first and second laser triangulation sensors.

In an embodiment, the laser sensor arrangement further comprises a first laser configured to emit light within the first bandwidth; and a second laser configured to emit light within the second bandwidth. Advantageously, each laser sensor is associated with a different laser and the laser position with respect to the laser triangulation sensor may be optimally determined. Alternatively, a single laser device may be used to emit light in both the first and second bandwidth simultaneously, e.g., using a dual-wavelength laser.

In a further embodiment, the first laser is rigidly coupled to the first laser triangulation sensor forming a first laser-sensor pair, and the second laser is rigidly coupled to the second laser triangulation sensor forming a second laser-sensor pair. The rigid coupling between the respective lasers and sensors ensures that the relative positioning of the electrical components with respect to each other is precisely known. Alternatively, the position and orientation of each of the electrical components may be measured and/or determined independently of each other. The sensors may for example be cameras.

In an embodiment, each of the first filtering means and second filtering means include one or more optical filters. Here the term “optical filter” refers to a device used to selectively transmit or block specific wavelengths of light. Suitable optical filters include but are not limited to notch filters, bandpass filters, long pass filters and short pass filters. Advantageously, optical filters are relatively easy and cheap to apply. In addition, they are easy to change if a laser is set to a different frequency. The optical filters may be arranged directly in front of the laser triangulation sensor, thereby ensuring that only light within a desired bandwidth is received by the laser sensor. Typically, only a single filter is used per sensor to attenuate the light at the desired frequencies as little as possible. Nevertheless, in alternative embodiments, more than one optical filter, e.g., a long pass and short pass filter, may be arranged in front of each sensor to obtain a desired bandwidth of frequencies that may be received and are not received by the sensor.

In an embodiment, the filtering means are configured to permit light at a selected center wavelength and a bandwidth of approximately ±5 nm around it, more preferably ±2 nm. Such bandwidths may be achieved using a bandpass filter arranged in front of the first and/or second laser triangulation sensor. In this context, the term “bandpass filter” is used to refer to a filter that is designed to block all visible wavelengths except the desired wavelength with little intensity loss. Advantageously, only the frequencies of the laser are permitted, and noise cause by ambient light is reduced to a minimum. In addition, only a single filter is used in front of each sensor which provides optimal transmissibility.

In an embodiment, the first bandwidth and the second bandwidth are both in the infrared spectrum, preferably wherein the first and second light have a wavelength between 700 nm and 900 nm. Here the term “visible light” refers to light with wave lengths in a range of approximately 400 to 700 nm, which is light that humans can see with the naked eye. The term “infrared light” refers to light with a wave length between 700 nm and 1 mm. Advantageously, visible light cameras which have some visibility in the infrared spectrum as well, may be used as sensor.

In an embodiment, the first laser and/or second laser emit light at a wave length wherein the spectrum of solar radiation has a local minimum. For example, the first laser may emit light at a first wavelength of 760 nm, and the second laser may emit light at a second wavelength of 808 nm. By selecting wave lengths where the natural solar irradiance is low, the noise received by the respective sensors is minimized. This allows to minimize the strength of the laser, and thus to use a less strong power source. It will be understood by the skilled person that there are also other wave lengths with reduced solar irradiance, that such wave lengths may vary with location, and that in certain embodiments different wave lengths may be selected for a different reason. For example, when using the laser triangulation sensor arrangement in a tunnel wherein artificial lighting prevails.

In an embodiment, the laser triangulation sensor arrangement is configured to perform laser line triangulation, wherein the first and second sensors are aligned to measure a single transverse profile of the surface. With a single laser-sensor pair, laser line triangulation can be used to capture a single transverse profile of the surface (e.g., the road pavement). Here the term “transverse” is used to indicate the direction substantially perpendicular to a longitudinal travel direction of a vehicle, such that a vehicle travelling in the longitudinal direction and carrying a laser triangulation sensor arrangement that repeatedly performs laser line triangulation is able to obtain 3D measurements. When multiple sensors are used, the sensors need to be aligned such that the measured transverse profile by all sensors together can be combined to form a single transverse profile. Advantageous to measuring a single transverse profile only is that the postprocessing of the data is easier. Specifically, combination of the measured data is more straightforward and smoother results may be obtained. The calibration of said multiple sensors is easier and more straightforward when the laser line is arranged in a single line.

In an embodiment, the first laser sensor and second laser sensor are spaced from each other along a transverse axis. Here the term “transverse axis” is used to indicate an axis parallel to the orientation of the transverse profile. Preferably, the sensors are spaced along the transverse axis in order to span a larger width. In embodiments, the spacing between the sensors is between 1 m and 3 m, preferably between 1.5 m and 2.5 m. Alternatively, or in addition, the sensors may have a different orientation with respect to each other.

In an embodiment, the positioning of the laser sources and laser sensors is substantially mirror symmetric in a longitudinal axis perpendicular to the transverse axis. Advantageous to a symmetric setup is that it simplifies post-processing and stitching together the data collected by the individual sensors.

In an embodiment, the first and second laser are configured to emit light continuously. Advantageously, the sensor exposure time is maximized. The continuous emission of light is possible since interference between the first and second sensors is omitted using the filtering means. Beneficial to maximizing the sensor exposure time is that it enables the use of lasers at a lower power without losing accuracy.

In an embodiment, each laser has a minimum power of 1.2 W and/or a maximum power of 6 W, optionally a minimum power of 2.5 W. Advantageously, a minimum power of 2.5 W ensures that the light strength is sufficient for the laser to be distinguishable over natural solar irradiance and/or other ambient light. In addition, by limiting the maximum power of each laser, it is not needed to take special safety precautions with respect to the emitted light. More precisely, a higher power laser source could create an eye safety hazard for any person or animal around the system when operated.

In an embodiment, the first and second sensors include cameras. Alternatively, the sensors may for instance be a photodetector or a charge-coupled device (CCD) capable of rapidly capturing the reflected laser light and converting it into precise distance measurements, providing high-resolution surface topography data.

In an embodiment the laser triangulation sensors have a field of view of at least 50 degrees, preferably at least 60 degrees. Advantageously, a sensor with such a field of view can sense a target area having a width of approximately 2.3 m if mounted at a distance of 2 m above the surface to be measured. Consequently, a laser triangulation sensor arrangement with two sensors, when properly aligned, is suitable to measure a width of a lane of a road whilst traveling on it. In embodiments, the laser triangulation sensor arrangement is configured to measure a surface having a width of at least 3 m, preferably at least 4 m, more preferably at least 4.25 m. Advantageously, the laser triangulation sensor arrangement can measure the full width of a roadway travel lane while moving along the travel lane only once. The skilled person will understand that conventional roads are typically at least 3.5 m. Preferably, a larger scanning width is selected to allow for the scanner arrangement on different types of roads with a different lane width.

In an embodiment, the first laser-sensor pair and the second laser-sensor pair each have a profile speed of at least 25 kHz, preferably at least 30 kHz. Here the term “profile speed” is used to indicate the speed at which the laser triangulation sensors can measure data. The profile speed can affect the quality and precision of the work being done. Higher speeds may lead to faster processing times and lead to a higher resolution in a vehicle's travel direction, while lower speeds can result in finer details and better accuracy of each transverse surface profile that is measured.

In an embodiment, the profile speed may be larger than 30 kHz, for instance 50 kHz, 100 kHz, or 200 kHz. It will be understood that a higher profile speed is advantageous when the laser triangulation sensor arrangement is subjected to movement. By increasing the frequency, higher resolutions may be obtained and/or the same resolution can be obtained while the laser triangulation sensor arrangement is subjected to a faster movement.

In an embodiment, the profile speed of the first sensor and/or the second sensor is selected to obtain a measurement resolution/accuracy of at least 1 mm in the vehicle travel direction given an advised or maximum road speed. Advantageously, the vehicle can measure a travel lane during normal traffic.

In an embodiment, the first and second bandwidths do not overlap. Typically, the first and second bandwidth are spaced from each other, e.g., non-overlapping. Nevertheless, in embodiments the light frequencies emitted by the first and second lasers may overlap, wherein the light frequency bandwidths do not overlap each other in a bandwidth wherein one of the first and second filtering means permits light.

In an embodiment, the first filtering means permit passage of light within the first light frequency bandwidth and allow the first sensor to receive light within the first light frequency bandwidth. The second filtering means permit passage of light within the second light frequency bandwidth, allowing the second sensor to receive light within the second light frequency bandwidth.

According to an important aspect of the invention, and in accordance with the advantages and effects as described herein above, there is provided a survey mechanism comprising a laser triangulation sensor arrangement according to the invention and configured to measure a single transverse surface profile; a navigation system configured to measure and output a position of the survey mechanism at a given time; and an inertial measurement unit configured to measure and output an orientation of the survey mechanism at the given time. Advantageously, a standalone survey mechanism for collecting surface data is provided. The navigation system and inertial measurement unit can collectively output x, y, z, and t values of the survey mechanism for each interval. The topographical images collected by the sensor arrangement at each interval can then be stitched together to form a full three-dimensional topography of the road. The survey mechanism may for instance be mounted on a moving vehicle such as a car, truck, trailer, van, scooter, go kart, train, locomotive, wagon, airplane, helicopter, drone, or other moveable object to take measurements of a target surface.

In an embodiment, the survey mechanism further comprises a rigid frame assembly, wherein the navigation system, the inertial measurement unit, and the laser triangulation sensor arrangement are coupled to the rigid frame assembly. Due to the rigid frame assembly, the position and orientation of the lasers and sensors in the laser arrangement can be directly derived from the data outputted by the navigation system and the inertial measurement unit.

In an embodiment, the survey mechanism further comprises a coupling assembly configured to detachably couple the rigid frame to a vehicle. Advantageously, the detachable coupling mechanism allows the survey mechanism to be used on a wide variety of vehicles with relative ease by allowing the frame to be removed and attached to vehicles of different sizes. Beneficially, maintenance on the vehicle and the survey mechanism can be performed independently. In addition, smaller and/or less tall vehicles may be selected for certain types of jobs. Alternatively, components of the survey mechanism may be directly mounted to a vehicle. In such embodiments, the navigation system and/or the inertial measurement unit may be integrated components of the vehicle.

In an embodiment, the survey mechanism further includes at least one camera coupled to the frame.

In an embodiment, the at least one camera faces a horizontal direction that is substantially parallel to the surface.

In an embodiment, the at least one camera is communicably coupled to the navigation system and the inertial measurement unit.

In an embodiment, the survey mechanism further includes a rear pod and a front pod.

In an embodiment, the survey mechanism further includes a Light Detection and Ranging (LiDAR) sensor coupled to the frame and configured to detect a distance from the LiDAR sensor to an object.

In an embodiment, the survey mechanism further includes a front pod and a rear pod, wherein the front pod is arranged around a front pod common reference point defined as a virtual point within a LiDAR sensor of the front pod, and the rear pod is arranged around a rear pod common reference line that is defined as a virtual line extending through a vertical axis of a rear antenna of the rear pod.

In an embodiment, the survey mechanism further includes a front pod and a rear pod, wherein the navigation system includes a front navigation antenna positioned on the front pod, and a rear navigation antenna positioned on the rear pod.

In an embodiment, the survey mechanism further includes a data logger communicably coupled to, and configured to store data output by, the at least one three-dimensional sensor, the navigation system, and the inertial measurement unit.

In an embodiment, the survey mechanism further includes a shaft encoder associated with at least one wheel of the vehicle and configured to output data indicating a movement amount of the at least one wheel. Alternatively, the survey mechanism may be electrically connected to an onboard computer of the vehicle, wherein the onboard computer outputs data indicating movement of the vehicle.

According to yet another aspect of the invention, and in accordance with all the advantages as described and discussed herein above, there is provided a vehicle comprising a laser triangulation sensor arrangement according to the invention. The vehicle may for instance be a road vehicle such as a car, truck, trailer, van, scooter, or go kart; a rail vehicle, such as a train, locomotive, wagon, or kart; or a flying vehicle such as an airplane, helicopter, drone, or other transportable object. In embodiments, the vehicle may be manned or may be autonomous and operate with little or no real-time interaction by a human operator.

In an embodiment, the distance between the surface to be measured and each of the first laser sensor and the second laser sensor is between 1 m and 3 m, preferably between 1.5 and 2.5 m, more preferably at maximum 2.1 m. In this context the distance of each sensor to the surface may be measured as the shortest distance in a straight line from the respective sensor to any point on the surface to be measured. Advantageously, a shortest distance between 1 m and 3 m provides a good balance between the required strength of the lasers, the accuracy that is obtained, a focus distance of the sensors, the size of the line/area that can be measured and the risk of damage of equipment. Specifically, when the vehicle is a road vehicle or a rail vehicle, physical constraints such as bridges, tunnels or other obstacles may limit the available height for positioning the sensor with respect to the surface. A design height of for instance 2.1 m could be used to prevent that the laser arrangement is mounted at a position where they run a high risk of impact. It will be understood, however, that this mounting height may vary based on the object that the laser arrangement is mounted to, and the application for which the laser arrangement is to be used.

In an embodiment, the surface is a road surface, rail track, or another type of driving surface. In this context, the term driving surface is considered to include all types of navigable land surface, including but not limited to roads, highways, airport runways, airport tarmacs, train tracks, and surface areas such as parking lots. Advantageously, the sensor arrangement may be configured to measure a line profile and be mounted on a moving vehicle and used to obtain a three-dimensional topography of the surface.

In an embodiment, the laser triangulation sensor arrangement is configured to perform laser line triangulation and the vehicle further comprises a navigation system configured to measure and output a position of the vehicle at a given time; and an inertial measurement unit configured to measure and output an orientation of the vehicle at the given time. The navigation system and inertial measurement unit may be integrated in the car, or alternatively, may be provided with the laser arrangement.

According to yet another aspect of the invention and in accordance with the advantages and effects as described herein above, there is provided a method for measuring a three-dimensional topography of a surface using a moving vehicle, wherein the vehicle moves along a trajectory and wherein the method comprises: emitting a first laser beam within a first light frequency bandwidth; simultaneously emitting a second laser beam within a second light frequency bandwidth; receiving, with a first sensor, an angled reflection of the light within the first frequency bandwidth while blocking light reflections at the second light frequency bandwidth; and simultaneously receiving, with a second sensor, an angled reflection of the light within the second frequency bandwidth while blocking light reflections at the first frequency bandwidth. The laser triangulation sensor arrangement can measure the topography of the road by measuring the topography at regular intervals. The laser beams are typically emitted continuously, yet it will be understood by the skilled person that laser line triangulation can also be formed using interrupted discontinuous laser pulses.

In an embodiment, the vehicle moves at a speed of at least 50 km/h, preferably at least 80 km/h, more preferably at least 100 km/h, or 120 km/h. Advantageously, the vehicle can participate in normal traffic without causing any delays.

In an embodiment, the method further comprises, performing an image analysis using the data received by the first and second sensor, and calculating a distance using laser line triangulation techniques. Such post-analysis may be done while the vehicle is travelling, using equipment on board of the vehicle, or may be done elsewhere offline.

It will be understood by the skilled person that the invention is not limited to the use of two pair of laser lights and sensors only. In embodiments, the laser triangulation sensor arrangement may comprise additional laser lights and additional sensors, each configured to emit light in a specific bandwidth and provided with filtering means to minimize or attenuate interference by the other lasers. It will further be understood that dependent on the spatial configuration of the lasers and sensors, certain laser and sensor pairs may operate within the same bandwidth as long as their operating areas are sufficiently spaced apart in the geospatial domain.

### BRIEF DESCRIPTION OF THE SEVERAL VIEWS OF THE DRAWINGS

The present technology will be described with reference to the appended drawings. The drawings aid in the description of the present technology and are not to be considered to be limiting the scope of the appended claims. The accompanying drawings include:

FIG. 1 illustrates a side view of a schematic representation of a vehicle with a survey mechanism including a laser triangulation sensor arrangement according to a first embodiment of the invention.

FIG. 2 illustrates a side view of a schematic representation of a vehicle with a survey mechanism and a laser triangulation sensor arrangement according to a second embodiment of the invention.

FIG. 3A illustrates a perspective view of a survey mechanism according to at least some of the presently disclosed embodiments.

FIG. 3B shows a detail of the survey mechanism as indicated in FIG. 3A.

FIG. 4 shows a bottom perspective view of a laser triangulation sensor arrangement according to at least some of the presently disclosed embodiments.

FIG. 5A-5B schematically illustrate the laser beams as emitted by the laser line triangulation arrangement according to the embodiment in FIG. 3. FIG. 5A illustrates a front view and FIG. 5B illustrates a top view.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

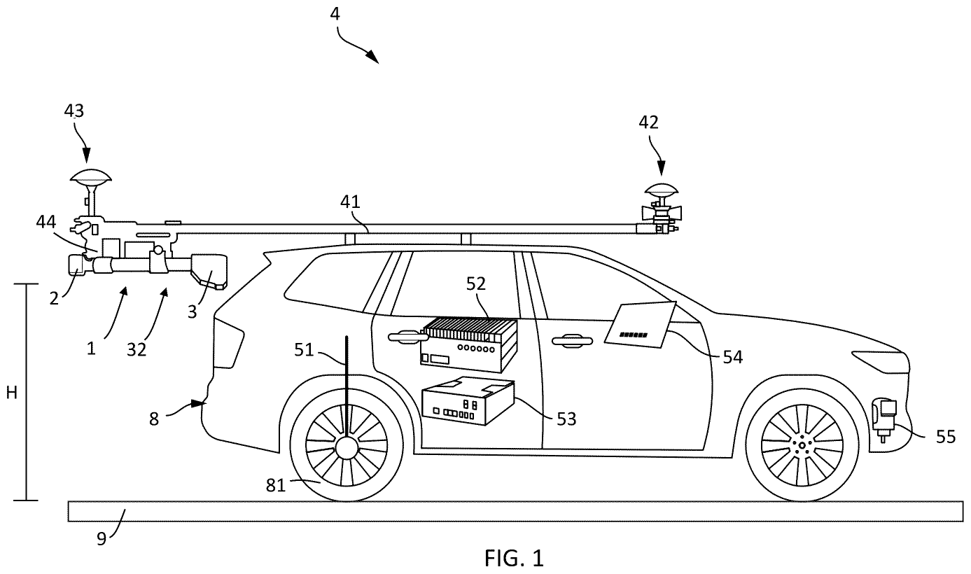

FIG. 1 schematically represents a side view of a vehicle 8 having a survey mechanism 4 with a laser triangulation sensor arrangement 1 for measuring a 3D topography of a surface 9 according to at least some of the presently disclosed embodiments.

The laser triangulation sensor arrangement 1 comprises a plurality of lasers 2 (only one visible) and a plurality of sensors 3 (only one visible). The survey mechanism 4 further comprises a frame 41, a front pod camera 42 a rear pod camera 43 and an inertial measurement unit 44. Arranged in the vehicle 8 and associated with the survey mechanism 4 are a plurality of electrical components, which are indicated schematically. The electrical components include a shaft encoder 51, a control computer 52, a data logger 53, a user interface 54, and an auto-start sensor 55.

The lasers 2 and sensors 3 are rigidly connected to each other and form laser-sensor pairs 32 that are capable of performing laser triangulation. Laser triangulation is a technique used for measuring distances or shapes using a laser beam. In some embodiments, the laser sensor 3 is a camera, and the surface is measured by projecting laser light onto a surface and taking an image of that surface at an angle with the sensor 3. By analyzing the image, the distance between the laser source and the surface can be calculated, enabling precise measurements and three-dimensional scanning applications. This two-dimensional image can be taken at regular intervals, and the multiple two-dimensional images can then be “stitched” together during computer processing to form a three-dimensional image.

The lasers 2 and sensors 3 can be any type of lasers 2 and sensors 3 capable of carrying out laser triangulation. For example, the lasers 2 can be a semiconductor laser diode emitting a narrow and coherent beam with sufficient power and wavelength stability for accurate distance measurements. The sensors 3 can be a photodetector or a charge-coupled device (CCD) capable of rapidly capturing the reflected laser light and converting it into precise distance measurements, providing high-resolution surface topography data.

As shown, the survey mechanism 4 with laser triangulation sensor arrangement 1 is detachably coupled to the vehicle 8. The vehicle 8 can be any movable object that can be controlled by a person or computer. In some embodiments, the vehicle 8 is a car, truck, trailer, scooter, go kart, airplane, helicopter, or any other transportable object. In some embodiments, the vehicle is autonomous and operates with little or no real-time interaction by a human. The laser triangulation sensor arrangement 1 may be coupled to the frame 41 of the survey mechanism 4 at various positions, but preferably is arranged at a rear side of the vehicle 8 and below a maximum height of the vehicle 8. This reduces the risk that the laser sensor arrangement 1, which is relatively costly and fragile, gets damaged during use. In some embodiments, the laser sensor arrangement 1 may also extend above a maximum height of the vehicle 8. In embodiments, the sensors 3 of the laser triangulation sensor arrangement 1 are provided at a distance H between 1 meter and 2.1 meters above the surface 9. Advantageous to the detachable survey mechanism 4 is that it can be used with a large variety of different vehicles. It will be understood that a preferred distance H may be partially dependent on the vehicle that is used.

The auto-start sensor 55 is configured to provide a signal to the control computer 52 to initiate the collection of data upon the sensing of vehicle movement. For example, the auto-start sensor 55 can be a motion sensor, such as an accelerometer or a Doppler radar sensor, installed within the housing of the vehicle 8 or attached to a chassis of the vehicle 8. Additionally, the auto-start sensor 55 may utilize global positioning data (e.g., GPS data or data from the navigation system) or wheel speed sensors to detect the onset of vehicle motion, ensuring precise synchronization between data collection and vehicle movement.

The shaft encoder 51 is associated with at least one wheel 81 of the vehicle 8 and is configured to output data indicating a movement amount of the at least one wheel 81. The shaft encoder 51 can be any device for measuring the movement of at least one wheel of the vehicle 8. For example, the shaft encoder 51 can be an optical encoder that utilizes a rotating disk with slots or markings to generate electrical pulses as the wheel turns, providing precise measurements of distance traveled or rotational position. Alternatively, the shaft encoder 51 may employ a magnetic encoder, which utilizes the changes in magnetic field patterns as the wheel rotates to determine motion. Additionally, the shaft encoder 51 could be a mechanical encoder utilizing gears or other mechanical mechanisms to track wheel movement accurately.

The data logger 53 is communicably coupled to, and configured to store data output by, the sensors 3, the navigation system (not shown), front and rear pod cameras 42, 43, and inertial measurement unit 44. The data logger 53 can be any non-transitory computer-readable recording medium capable of recording, storing, and/or organizing data collected by the mechanism 4. For example, the data logger 53 can be a solid-state data storage device such as flash memory, a hard disk drive, or a solid-state drive. Alternatively, the data logger 53 may incorporate wireless communication capabilities to transmit real-time data to a remote server or a computing device for further analysis and processing. The data logger 53 can also feature encryption mechanisms to ensure the security and integrity of the stored surveying data. The data logger 53 can therefore act as a storage associated with the plurality of sensors 3 and inertial measurement unit 44 and can receive data from the plurality of sensors 3 and inertial measurement unit 44.

The control computer 52 can be any computing device capable of directly or indirectly controlling the vehicle 8 and/or survey mechanism 4. For example, the control computer 52 can be a traditional personal computer with desktop or laptop configurations, or a modern handheld device such as a smartphone or tablet. The control computer 52 can include storage for storing data output from the survey mechanism 4, user selections, an operating system for the control computer 52, applications and services necessary or helpful for the collection of data, or software for controlling the operation of the vehicle 8. The control computer 52 can also include a transceiver for transmitting and receiving data, as well as a processor for executing instructions, performing calculations, managing data flow, and serving as the central component responsible for carrying out computational tasks in the control computer 52. The control computer 52 can also provide the means for communicably coupling the navigation system and inertial measurement unit 44 by analyzing and synchronizing the data output therefrom. In this manner, the control computer 52 can communicably couple the at least one front or rear pod camera 42, 43 to the navigation system and the inertial measurement unit 44.

The user interface 54 can be any component capable of allowing user interaction with the data collected by the survey mechanism 4 and/or the controls of the survey mechanism 4. For example, the user interface 54 can be a touchscreen display integrated into the survey mechanism 4, providing intuitive access to collected surveying data, control settings, and system diagnostics. Alternatively, the user interface 54 may include physical buttons, knobs, or switches along with a liquid crystal display (LCD) screen or light-emitting diode (LED) indicators for displaying relevant information and facilitating user input. Furthermore, the user interface 54 can incorporate audio feedback or voice commands to enhance usability. In some embodiments, the user interface 54 is incorporated into the vehicle 8 as a non-detachable fixture. In other embodiments, the user interface 54 is detachable, and is a tablet, personal computer, smart phone, or any other device capable of collecting user input. The user interface 54 can include navigation instructions, status reporting, error messages or other information necessary or helpful to the operation of the survey mechanism 4.

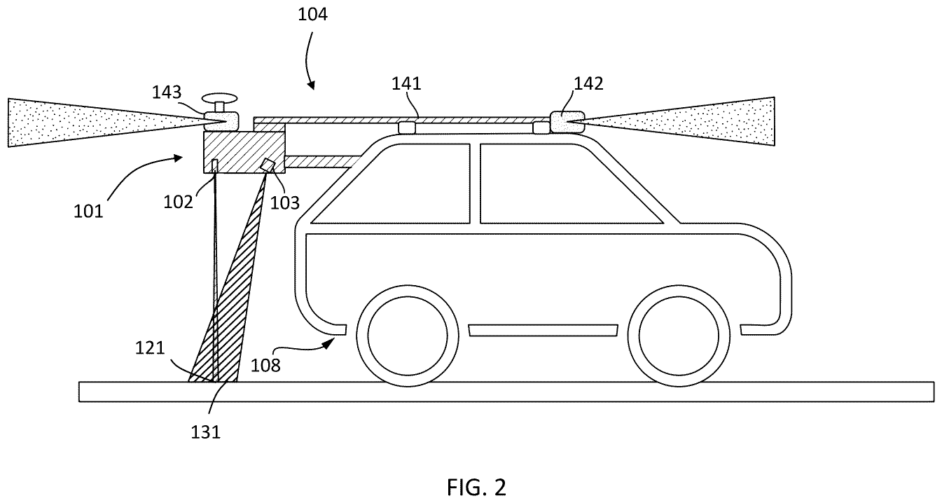

FIG. 2 schematically shows a side view of a vehicle 108 with a detachable survey mechanism 104 and laser triangulation sensor arrangement 101 according to an alternative embodiment. Features of the vehicle 108, survey mechanism 104, and laser triangulation sensor arrangement 101 that have already been described above with reference to the first embodiment may also be present in the embodiment shown in FIG. 2 and will not all be discussed here again. For the discussion with reference to FIG. 2, like features are designated with similar reference numerals preceded by 100 to distinguish the embodiments.

As shown, the lasers 102 emit a laser line 121 towards the surface 109. The sensors 103 are facing the surface 109 and have visibility within a target area 131 wherein the laser line 121 is projected. The plurality of sensors 103 are arranged to receive an angled reflection of the laser line 121 and to carry out the laser triangulation at any interval. In an embodiment, the laser sensors 103 capture an image at a rate of approximately 28 KHz.

The front pod camera 142 and rear pod camera 143 can capture images at selected intervals. In an embodiment, the front pod camera 142 and/or the rear pod camera 143 can capture images at predefined intervals. For example, in an embodiment, the cameras 142, 143 can capture images at predetermined time intervals. In another embodiment, the cameras 142, 143 can capture images every 6 m based on a distance driven as determined by the navigation system and/or the shaft encoder 51 measuring movement of the at least one wheel. Any other manner of measuring vehicle movement or time can be implemented, for example, by outputting data from the vehicle odometer, visual odometry, or any other method.

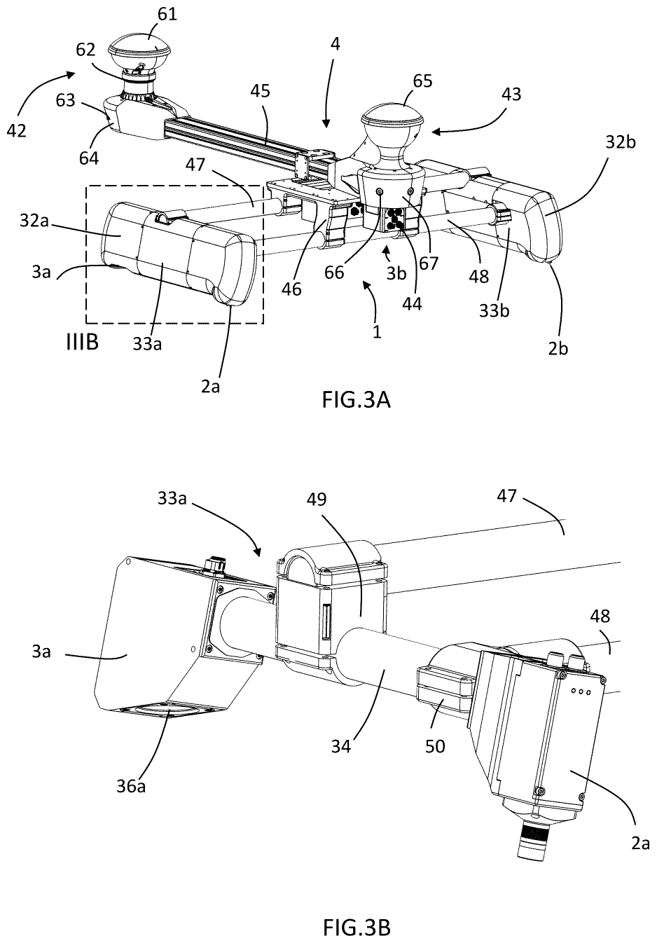

FIG. 3A shows a perspective view of the survey mechanism 4 with a laser triangulation sensor arrangement 1 according to the embodiment depicted in FIG. 1. The survey mechanism 4 includes a frame 46 with a beam 45 that extends longitudinally and connects the front pod 42 and rear pod 43. The frame 46 further includes a front crossbar 47 and rear crossbar 48 extending in a transverse direction substantially perpendicular to the longitudinal direction.

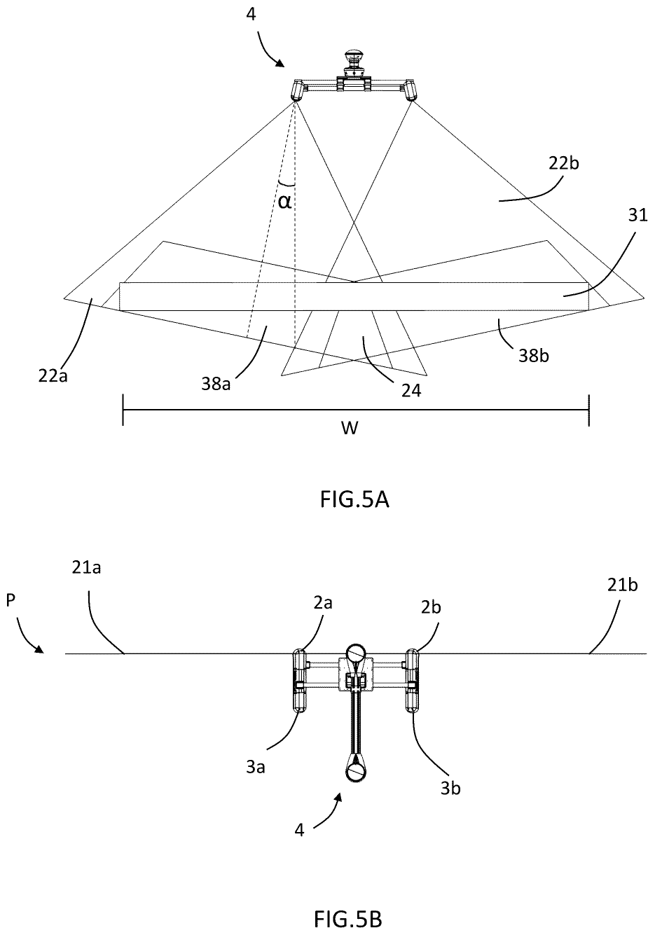

Two laser-sensor pairs 32a, 32b are provided in protective casings 33a, 33b and rigidly mounted to the crossbars 47, 48. The laser-sensor pairs 32a, 32b are spaced from each other along the transverse direction and angled outwards, i.e., away from each other. The field of view of the sensors 3a, 3b overlaps slightly to ensure full coverage of the surface while also allowing the overlap region to act as control for the sensor accuracy. More precisely, within the overlap region, the measurements as retrieved from the different sensors 3a, 3b should be in agreement with each other. If a discrepancy is found, the control computer 52 may flag this and send a message for display on the user interface 54 that the sensors 3a, 3b require recalibration. As will be described below in more detail and with reference to FIG. 5, the laser triangulation sensor arrangement 1 can determine the three-dimensional topography of the surface through laser line triangulation.

The front pod 42 can include a front antenna 61 and a Light Detection and Ranging (LiDAR) sensor 62. The front pod 42 can also include one or more front pod camera(s) 63 and a front cover 64 surrounding the front pod camera(s) 63. Similarly, the rear pod 43 can include a rear antenna 65 and rear pod camera(s) 66, with a rear cover 67 surrounding the rear pod camera(s) 43. The at least one camera 63,66 can be coupled to the frame 46. An inertial measurement unit 44 can be coupled to the rear pod 43 for measuring an orientation of the mechanism at a given time. In some embodiments, the rear pod 43 is rigidly coupled to the beam 45, which itself is rigidly coupled to the front pod 42, which is rigidly coupled to the frame 46, to comprise the entire rigid system of the survey mechanism 4.

The front pod 42 can provide data more easily captured from the front portion of a vehicle 8 through the various components of the front pod 42. The front pod 42 can include a front pod common reference point. For example, and without limitation, the front pod 42 common reference point can be a virtual point at a base of the LiDAR sensor 62, and the rear common reference point can be a vertical axis that extends through the vertical axis of the rear antenna 65. This front common reference point can be the virtual point at which the LiDAR sensor 62 treats as its origin for purposes of computing x, y, and z values of measured objects. The LiDAR sensor 62 and front antenna 61 can be aligned along a vertical axis that extends through this point to simplify the data processing steps when digitally recreating the surface and surrounding topography. Similarly, the rear common reference point can be a point on a vertical line that extends through the vertical axis of the rear antenna 65. In some embodiments, the rear common reference point is a point on the cover of the inertial measurement unit 44. The lasers 2a, 2b, inertial measurement unit 44, and rear antenna 65 can all be aligned along a plane that extends through this line. By establishing these two known points, the survey mechanism 4 can understand the exact position of the front pod 42 and rear pod 43 during the measurement process and measure other values with respect to these common reference points. By maintaining two common reference points, this also allows the beam 45 to be different lengths depending on the specific project.

The front antenna 61 and/or rear antenna 65 can be an antenna associated with a navigation system that measures and outputs a global position of the mechanism. To this end, the front antenna 61 and/or the rear antenna 65 can individually or collectively act as a navigation system coupled to the frame 46 and can be configured to measure and output a position of the survey mechanism 4 at a given time. For example, the navigation system can be a global positioning system (GPS), a global navigation satellite system (GNSS), an inertial navigation system (INS), a radio frequency identification (RFID) navigation system, a dead reckoning navigation system, a visual odometry system, a celestial navigation system, a beacon-based navigation system, a laser-based navigation system, or a magnetic navigation system.

The LiDAR sensor 62 can be coupled to the frame 46 and configured to detect a distance from the LiDAR sensor 62 to an object. The LiDAR can use eye-safe laser beams to “see” the world in three dimensions. For example, the LiDAR sensor 62 emits laser pulses towards objects in its vicinity and measures the time it takes for the pulses to reflect back to the sensor after reaching the objects. By precisely timing the return of these pulses, the LiDAR sensor 62 calculates the distance to each object, creating a detailed three-dimensional map of the environment. The LiDAR sensor 62 is also able to output distance measurement data so that the system can correlate that data with images captured by the front pod camera 63 or rear pod camera 66. In this manner, the distance to the images can be determined. Additionally, the LiDAR sensor 62 captures the intensity of the returned laser light, providing information about the objects' reflectivity or material properties.

The front pod camera(s) 63 and the rear pod camera(s) 66 can be coupled to the frame 46 and can face a substantially horizontal direction that is substantially parallel to the surface upon which the vehicle is traveling. The front pod camera(s) 63 and rear pod camera(s) 66 can be any camera capable of capturing all or part of an image. For example, the front pod camera 63 can be a digital single-lens reflex (DSLR) camera, a mirrorless camera, a compact digital camera, a panoramic camera, a thermal imaging camera, a multispectral camera, or a hyperspectral camera. The choice of camera depends on factors such as the desired image resolution, spectral sensitivity, field of view, and environmental conditions in which the surveying mechanism operates. By employing a suitable camera, the front pod camera(s) 63 facilitates the acquisition of high-quality visual data essential for precise surveying and mapping applications. The rear pod camera(s) 66 can be the same type of camera as the front pod camera 63 or, in some embodiments, is a different camera. Further, as will be described in more detail below, the front pod camera 66 and rear pod camera 63 can be a plurality of cameras angularly separated to capture a wide range of images, in some cases 360 degrees of images.

The frame 46 acts as the structural backbone of the survey mechanism 4. The beam 45 can be considered part of the frame 46 in some embodiments, because the front pod 42 couples to the rear pod 43 via the beam 45. The crossbars 47, 48, beam 45, and the frame 46 can be rigid so that locational accuracy can be confirmed within the data collected by the survey mechanism 4. In general, the term “frame 46” is meant to be interpreted broadly as including any structural component upon which the functional components of the survey mechanism 4 are coupled.

In an embodiment, the frame 46 is formed by an extrusion technique. For example, the frame 46 can be made of an extrudable material characterized by properties that facilitate a transformation of the extrudable material into a beam shape via an extrusion technique. The material may include, but is not limited to, metals such as aluminum or steel, plastics, or composite materials, each selected for their balance of strength, durability, and weight.

The extrusion process can involve forcing the chosen material through a die to achieve the desired cross-sectional profile, which is specifically designed to optimize the structural integrity and functionality of the frame 46. This process allows for the creation of complex cross-sectional shapes that are uniform in density and consistency, enhancing the load-bearing capacity and resistance to environmental stresses for the frame 46. Additionally, the extrusion technique enables the integration of features such as channels for wiring or aerodynamic contours directly into the frame 46 structure, reducing the need for additional components and simplifying assembly. The use of extrusion in forming the frame 46 not only ensures a high degree of precision and uniformity in the production process but also offers the flexibility to tailor the properties of the frame 46, such as rigidity, flexibility, and thermal conductivity, to specific application requirements.

The survey mechanism 4 can include a coupling mechanism configured to detachably couple the frame 46 to a vehicle. In doing so, the survey mechanism does not require a dedicated vehicle but instead can be removed from one vehicle and attached to another. The coupling mechanism can be, for example, a clamp system, magnetic attachment, suction device, mechanical fasteners such as bolts or screws, snap-fit connectors, locking pins, hook-and-loop fasteners, adhesive bonding, quick-release mechanisms, or any combination thereof. Additionally, the coupling mechanism may incorporate adjustable or telescoping features to accommodate different vehicle dimensions, as well as built-in safety locks or release triggers to enhance security and ease of detachment when required. The coupling mechanism also may include shock and vibration damping components. These shock and vibration components decouple the dynamics of the vehicle from the survey mechanism 4 to achieve better data collection precision.

The inertial measurement unit 44 can be coupled to the frame 46 and configured to measure and output an orientation of the survey mechanism 4 at a given time. In an embodiment, the inertial measurement unit 44 can measure and report acceleration, angular rate, and magnetic field data, enabling tasks such as motion tracking, navigation, and stabilization.

The inertial measurement unit 44 can be any device capable of measuring the inertia of the vehicle 8 and/or the survey mechanism 4 and an angle thereof. For example, the inertial measurement unit 44 can be an Inertial Measurement Unit (IMU) incorporating accelerometers, gyroscopes, and magnetometers to precisely determine the vehicle's linear and angular motion in three-dimensional space. Alternatively, the inertial measurement unit 44 can include MEMS (Micro-Electro-Mechanical Systems) sensors, fiber optic gyroscopes, or piezoelectric sensors, each offering unique advantages in terms of size, accuracy, and power consumption for effectively monitoring and analyzing the vehicle's dynamics and orientation.

The navigational system and inertial measurement unit 44 can be designed to determine precise spatial and orientation data in a global reference frame. Specifically, these features can collectively deliver coordinates in three dimensions (X, Y, Z), orientation data (heading, roll, pitch), and time synchronization, all referenced to the navigation system framework. The orientation components-heading, roll, and pitch are ascertained based on local-level measurements, correlating with gravitational forces at the specific location of measurement. The system utilizes a defined geometric relationship, encompassing both the coordinates (X, Y, Z) in the frame 46 and rotational angles around these three axes. Understanding this geometric configuration, the system is capable of translating the sensor-specific data into the global context.

The laser-sensor pairs 32a, 32b are coupled to the frame 46 in a positionally rigid manner such that they each define a predetermined position relative to the frame 46. The lasers 2a, 2b and sensors 3a, 3b of the laser-sensor pairs 32a, 32b face the surface 9 upon which the vehicle is traveling in a substantially vertical direction and are configured to measure the three-dimensional topography of the surface.

FIG. 3B shows a detail of the survey mechanism 4 and laser triangulation sensor arrangement 1 as indicated in FIG. 3A. The casing 33a is removed in FIG. 3B to provide a better depiction of the internal components. The first laser 2a and first laser sensor 3a are rigidly coupled to each other through a connector piece 34. The crossbeams 47, 48 each are provided with a coupling element 49, 50 arranged to clamp the tubular connector piece 34 and to form a rigid coupling therewith. In alternative embodiments, the coupling element can be, for example, a clamp system, magnetic attachment, suction device, mechanical fasteners such as bolts or screws, snap-fit connectors, locking pins, hook-and-loop fasteners, adhesive bonding, quick-release mechanisms, or any combination thereof.

The first sensor 3a is a camera with an image sensor, a lens, and an optical filter 36a provided directly in front of the lens. The lens focuses light onto the image sensor. The optical filter 36a is provided directly before the lens, such that only light of a certain frequency bandwidth is received by the image sensor. Likewise, the second sensor (not shown) is a camera with image sensor, lens, and optical filter.

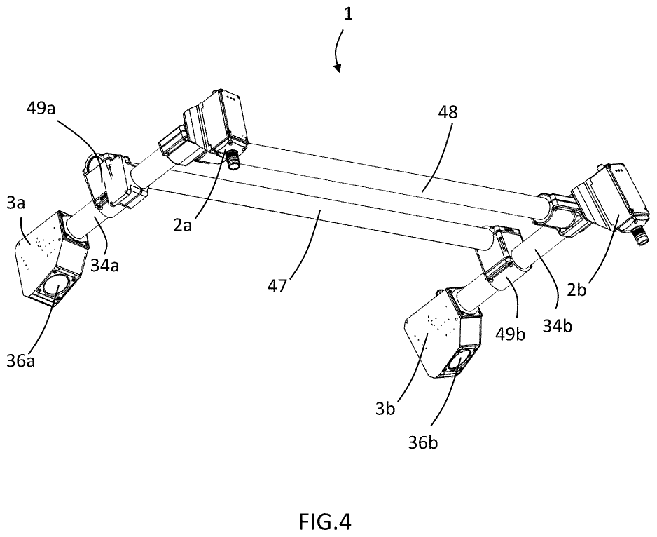

FIG. 4 shows a bottom perspective view of the laser sensor arrangement 1 in any of the previously described embodiments. The protective casings 33a, 33b have been removed to provide a better depiction of the internal components. Each laser sensor 3a, 3b is provided with an optical filter.

The first laser 2a emits light at a frequency of 760 nm, and, correspondingly, the first optical filter 36a is a bandpass filter arranged to permit passage of light with a frequency of 760±5 nm. The second laser 2b emits light at a frequency of 808 nm, and, correspondingly, the second optical filter 36b is a bandpass filter arranged to permit passage of light with a frequency of 808±5 nm. All light having a wave length outside of these ranges is blocked by the optical filters 36a, 36b. As a result, the image sensor of the first camera 3a does not receive light emitted by the second laser 2b, and the image sensor of the second camera 3b does not receive light emitted by the first laser 2a. Advantageously, the optical filters 36a, 36b can be easily replaced and adjusted to the specific frequencies that the lasers 2a, 2b emit.

The first and second filtering means 36a, 36b are bandpass filters. Other suitable optical filters include but are not limited to notch filters,, long pass filters and short pass filters. The optical filters are arranged directly in front of a lens of the sensors 3a, 3b, thereby ensuring that only light within a desired bandwidth is received by the sensor 3a, 3b.

As shown, the first laser-sensor pair 32a is aligned along the longitudinal axis X, i.e., parallel to the beam 45 of the survey mechanism 4. In addition, the first laser-sensor pair 32a is mirror symmetric with the second laser-sensor pair 32b in the longitudinal axis X. Such alignment has certain advantages but is by no means required. In alternative embodiments such alignment and/or symmetry may be absent.

FIGS. 5A and 5B show the survey mechanism 4 according to the previously depicted embodiments, wherein the laser light beams 22a, 22b of the first and second lasers 2a, 2b, are schematically indicated. FIG. 5A shows a front view, and FIG. 5B a top view.

Each laser 2a, 2b is arranged to emit a beam 22a, 22b of laser light towards a surface to be measured (not shown). The surface to be measured is estimated to be within the target area 31, where the sensors 3a, 3b have visibility and are in focus. Visibility regions 38a, 38b depict the intersection of the visible range of the sensors 3a, 3b with the transverse plane P (see FIG. 5B) wherein the beams 22a, 22b of laser light are projected.

The beams 22a, 22b project a single laser line 21a, 21b onto the surface to be measured. Due to the alignment of the lasers 2a, 2b along the transverse axis, the lines 21a, 21b are coinciding and form a single transverse line having a length of approximately 5 m. The laser-sensor pairs 32a, 32b are aligned along the transverse axis and have an overlapping operating range such that a continuous transverse profile can be measured. The target area 31 has a width W of approximately 4.25 m. This is sufficiently wide for measuring a single travel line of a road.

As depicted in FIG. 5A, the visibility regions 38a, 38b of the sensors 3a, 3b overlap in the overlap area 24. The presence of an overlap area 24 ensures that surface can be continuously measured over its full width, without disruptions. More precisely, the overlap area 24 prevents that an area in between the beams 22a, 22b is not measured, e.g., in case of a bump in the road. The width of the profile where the field of view overlaps is approximately 0.5 m, but in embodiments this may also be larger or smaller.

The laser light beams 22a, 22b are emitted under an angle a of approximately 15 degrees with respect to a vertical direction perpendicular to the longitudinal and the transverse direction. Likewise, each sensor 3a, 3b is tilted outwards under an angle of 15 degrees. It will be understood that the tilting has an effect on the size of the overlapping area 24. For a larger angle a the size of the overlap area 24 is reduced and the width W of the target area 31 increased. In embodiments, the angle a may be any angle between −10 and 30 degrees. Preferably, however, the angle a is selected between 0 and 15 degrees as this yields most optimal results in terms of the accuracy of the measurements.

Each of the sensors 3a, 3b has an angle of view of approximately 63 degrees and is arranged at a design distance D of 2 m above the surface to be measured. Here the term “design distance” is used to indicate a distance to an expected position of the surface to be measured. Resulting from their angle of view and mounting position, the sensors 3a, 3b can measure a surface profile having a width of approximately 2.4 meters each.

The lasers 2a, 2b are configured to emit a light beam 22a, 22b continuously, such that the exposure time of the sensors 3a, 3b is maximized. Advantageously, continuous exposure allows for a reduction of the laser light intensity relative to alternatives wherein no continuous light is emitted. The first filtering means 36a and second filtering means 36b are provided to avoid sensor-to-sensor interference.

The components of the laser triangulation sensor arrangement 1 are operatively coupled to the other electrical components of the survey mechanism 4 and/or vehicle. The survey mechanism 4 can collect and store a wide variety of data with the various sensors. For example, and without limitation, the survey mechanism 4 can collect data relating to road and pavement data for maintenance, planning, or pavement management. This data can include, for example, raw road profile data, a longitudinal profile of the road, roughness or smoothness data, macro texture of the pavement surface, or any other physical road data. In particular, when the vehicle 8 is driven, the survey mechanism 4 can capture sequential transverse profiles of the pavement surface and when combined, these sequential transverse profiles form a three-dimensional pavement surface profile. The mechanism can also collect “above ground” data such as the location and shape of a street sign, guard rail, light pole, or other objects, with the various cameras 63, 66, and LiDAR sensor 62, and in some cases in association with the other components of the survey mechanism 4.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

Further, it should be appreciated that in the appended claims, reference to an element in the singular is not intended to mean “one and only one” unless explicitly so stated, but rather “one or more.”

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

The words “illustrative” or “exemplary” are used herein to mean “serving as an example, instance, or illustration.” Any aspect described herein as “illustrative” or “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

1. A laser triangulation sensor arrangement for measuring a surface profile, the laser triangulation sensor arrangement comprising:
a first sensor arranged to receive a reflection of light emitted by a first laser source within a first laser light frequency bandwidth;
a second sensor arranged to receive a reflection of light emitted by a second laser source within a second laser light frequency bandwidth;
first filtering means preventing the first sensor from receiving light within the second light frequency bandwidth; and
second filtering means preventing the second sensor from receiving light within the first light frequency bandwidth.

2. The laser triangulation sensor arrangement according to claim 1, further comprising:
a first laser configured to emit light within the first laser light frequency bandwidth; and
a second laser configured to emit light within the second laser light frequency bandwidth.

3. The laser triangulation sensor arrangement according to claim 1, wherein each of the first filtering means and second filtering means include one or more optical filters.

4. The laser triangulation sensor arrangement according to claim 1, wherein each of the first filtering means and the second filtering means are configured to permit light within a bandwidth of approximately ±5 nm around a selected center wavelength.

5. The laser triangulation sensor arrangement according to claim 1, wherein the first light frequency bandwidth and the second light frequency bandwidth are both in the within an infrared spectrum.

6. The laser triangulation sensor arrangement according to claim 1, wherein the laser triangulation sensor arrangement is configured to perform laser line triangulation, and wherein the first and second sensors are aligned to measure a single transverse profile of a surface associated with the surface profile.

7. The laser triangulation sensor arrangement according to claim 1, wherein the first sensor and the second sensor are spaced from each other along a transverse axis.

8. The laser triangulation sensor arrangement according to claim 1, wherein each of the first laser source and the second laser source are configured to emit light continuously.

9. The laser triangulation sensor arrangement according to claim 1, wherein the first and second sensors are cameras.

10. The laser triangulation sensor arrangement according to claim 1, wherein:
a first laser-sensor pair comprises the first laser source and the first sensor;
a second laser-sensor pair comprises the second laser source and the second sensor; and
the first laser-sensor pair and the second laser-sensor pair each have a profile speed of at least 25 kHz.

11. The laser triangulation sensor arrangement according to claim 1, wherein the first laser light frequency bandwidth and the second laser light frequency bandwidth do not overlap.

12. The laser triangulation sensor arrangement according to claim 1, wherein:
the first filtering means are configured to permit passage of light within the first laser light frequency bandwidth, and the first sensor is configured to receive light within the first laser light frequency bandwidth; and
the second filtering means are configured to permit passage of light within the second laser light frequency bandwidth, and the second sensor is configured to receive light within the second laser light frequency bandwidth.

13. The laser triangulation sensor arrangement according to claim 1, wherein the laser triangulation sensor arrangement is configured to perform laser line triangulation, and wherein the laser triangulation sensor arrangement further comprises:
a navigation system configured to measure and output a position of the laser triangulation sensor arrangement at a given time; and
an inertial measurement unit configured to measure and output an orientation of the laser triangulation sensor arrangement at the given time.

14. The laser triangulation sensor arrangement according to claim 13, wherein:
the laser triangulation sensor arrangement further comprises a rigid frame assembly; and
the navigation system, the inertial measurement unit, and one or more of the first sensor and the second sensor are coupled to the rigid frame assembly.

15. A vehicle comprising a laser triangulation sensor arrangement according to claim 1.

16. The vehicle according to claim 15, wherein the laser triangulation sensor arrangement is configured to perform laser line triangulation, and wherein the vehicle further comprises:
a navigation system configured to measure and output a position of the vehicle at a given time; and
an inertial measurement unit configured to measure and output an orientation of the vehicle at the given time.

17. A method for measuring a three-dimensional topography of a surface using a moving vehicle, wherein the vehicle moves along a trajectory and wherein the method comprises:
emitting a first laser beam within a first light frequency bandwidth;
simultaneously emitting a second laser beam within a second light frequency bandwidth;
receiving, with a first sensor, a first angled reflection of light corresponding to the first laser beam within the first light frequency bandwidth, wherein the first angled reflection of light is received by the first sensor while blocking light reflections within the second light frequency bandwidth; and
simultaneously receiving, with a second sensor, a second angled reflection of light corresponding to the second laser beam within the second light frequency bandwidth, wherein the second angled reflection of light is received by the second sensor while blocking light reflections within the first light frequency bandwidth.

18. The laser triangulation sensor arrangement according to claim 5, wherein each of the light emitted by the first laser source and the light emitted by the second laser source have a wavelength between 700 nm and 900 nm.

19. The laser triangulation sensor arrangement according to claim 14, wherein the laser triangulation sensor arrangement is a standalone survey mechanism for collecting surface data.
